(19) United States
(12) Patent Application Publication
(10) Pub. No.: US 2026/0274212 A1
(43) Pub. Date: Sep. 17, 2026

(54) REFUELING SYSTEM AND METHOD FOR AUTONOMOUS VEHICLES

(71) Applicant: Torc Robotics, Inc., Blacksburg, VA (US)

(72) Inventors: William Gray Davis, Austin, TX (US); Akshay Pai Raikar, Austin, TX (US); Savio Pereira, Austin, TX (US); Rasika Kangutkar, Austin, TX (US); Joseph R. Fox-Rabinovitz, Austin, TX (US)

(21) Appl. No.: 19/079,850

(22) Filed: Mar. 14, 2025

(51) Int. Cl. B60S 5/02; B60W 60/00

(52) U.S. Cl. CPC B60S 5/02; B60W 60/001; B60W 2530/209

(57) ABSTRACT

As described herein, an autonomous vehicle is equipped with a controller and is connected to a communication network to facilitate refueling. The vehicle communicates over the network or directly with a refueling vehicle via the controller. The communication may be triggered by a predefined refueling checkpoint created by mission control, or a critical level of fuel in a fuel tank of the vehicle. The vehicle controller transmits a refueling location and a visual indicia by which the vehicle can be identified. The vehicle travels to the refueling location. The refueling vehicle separately travels to the refueling location, identifies the vehicle, and establishes a refueling pose. A refueling controller or operator onboard the refueling vehicle directs a refueling operation. The refueling process ends and the vehicle proceeds with a predefined mission.

### TECHNICAL FIELD

The field of the disclosure relates to systems and methods for refueling autonomous vehicles and, in particular, to systems and methods for refueling autonomous vehicles during operation of the autonomous vehicle.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration. The behaviors and planning technologies, in combination with the controller, may also be used to define or identify refueling stations for refueling the autonomous vehicle as the vehicle operates along the route required to complete the vehicle mission.

In some cases, autonomous vehicles are powered solely by an internal combustion engine. In other cases, autonomous vehicles may be powered by a hybrid system including a combination of an internal combustion engine and one or more electric motors that use energy stored in batteries. Autonomous vehicles that are powered either by an internal combustion engine either as the single source of power to the vehicle or in combination with electric motors in a hybrid system, will be required to stop for fuel for use by the internal combustion engine.

In some cases, autonomous vehicles that are fully, or in part powered by internal combustion engines, may include long haul autonomous trucks, such as autonomous trucks that travel, for example, routes that total 250 miles or more. The long haul routes traveled by the autonomous trucks may require the autonomous truck to be operated along roads that do not have refueling stations or service hubs at regular locations along the road. Such roads may not have a refueling station or hub available when the autonomous truck is operating at a low fuel level and in need of refueling.

In an attempt to manage long haul autonomous truck refueling needs predictably, a predefined travel route for a specific autonomous vehicle mission may include the location(s) of refueling station(s) for planned refueling stops. However, during operation, the autonomous vehicle may encounter high vehicle volume traffic patterns, weather conditions, or other road events that require the vehicle to regularly modify vehicle speed. A pattern of vehicle acceleration and deceleration, or idling for long periods of time can negatively impact vehicle fuel efficiency. In such situations, the resulting fuel efficiency of the operating vehicle may be at a level that is below the fuel efficiency level that was used to identify the refueling stations(s) to be used for planned refueling stops. In such situations, the autonomous vehicle operating at a lower than planned fuel efficiency would need to be refueled sooner than planned. If the autonomous vehicle is operating on a road where service stations are not located at reasonably regular intervals, the autonomous vehicle could run out of gas before the autonomous vehicle reaches a service station and is effectively refueled.

When an autonomous vehicle makes a refueling stop at a refueling station, each refueling stop, although necessary for effective operation, increases the amount of time required for the vehicle to complete the defined travel mission. The refueling stations may be located a distance off of the road, requiring measurable time for the vehicle to exit the road, travel to the refueling station, refuel the vehicle, travel back to the road and enter the road to continue the mission. Frequently, multiple refueling stops may be required to complete a mission, further increasing the time required to complete the mission.

Accordingly, there exists a need for a system and a method to facilitate autonomous vehicle refueling that does not measurably increase the time to complete a mission, and also minimizes the likelihood that an autonomous vehicle will run out of fuel before the vehicle is able to be effectively refueled.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a vehicle is configured to execute a refueling procedure. The vehicle includes a communication module configured to communicate with a refueling vehicle and receive mission instructions from mission control. The vehicle further includes a controller configured to receive inputs from at least one sensor mounted on the autonomous vehicle and to determine a refueling location for performing the refueling process. The refueling location is determined based on the sensor inputs and the received instructions. The vehicle utilizes the communication module to coordinate with the refueling vehicle, and to control the movements of the vehicle, wherein the controller directs the vehicle to a refueling location. The vehicle further includes a non-transitory computer-readable storage medium for storing instructions received from mission control.

In another aspect, a method for refueling an autonomous vehicle is disclosed. The method includes receiving, via a communication module, a refueling location from a mission control system, wherein the communication module is connected to a controller of the autonomous vehicle. The method further includes communicating with a refueling vehicle to provide both a visual indicia identifying the autonomous vehicle and a location for the refueling, wherein the location for refueling is determined by the controller. The method further includes rendezvousing with the refueling vehicle at the refueling location, and maintaining a refueling pose, wherein the autonomous vehicle is positioned behind the refueling vehicle. The method further includes connecting a refueling nozzle of the refueling vehicle to a fuel port of the autonomous vehicle such that fuel can be added to a fuel tank on the vehicle.

In yet another aspect, a method for refueling an autonomous vehicle in a fuel emergency is disclosed. The method includes detecting, based on a sensor input, the amount of fuel left in a fuel tank of the autonomous vehicle and determining, using a controller of the autonomous vehicle, whether the amount of fuel has reached a critical level based on the detected amount. The method further includes broadcasting, via a communication module connected to the controller, a low fuel alert to a network of refueling vehicles and identifying a refueling location based on the amount of fuel remaining and expected mileage of the vehicle. The method also includes controlling, via the controller, the movement of the autonomous vehicle to the refueling location. The method additionally includes providing, to the refueling vehicle, a visual indicia which identifies the autonomous vehicle and rendezvousing at the refueling location. The method also includes maintaining a refueling pose, wherein the autonomous vehicle is positioned behind the refueling vehicle. The method further includes connecting a refueling nozzle of the refueling vehicle to a fuel port of the autonomous vehicle such that fuel can be added to a fuel tank on the vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein:

FIG. 1 is a perspective view of a vehicle;

FIG. 2 is a block diagram of an example autonomous driving system of the vehicle shown in FIG. 1;

FIG. 3 is a block diagram of an example computing system of the vehicle shown in FIG. 1;

FIG. 4 is a block diagram of a communication network infrastructure required for refueling a vehicle that is receiving fuel;

FIG. 5 is a flow diagram of a planned refueling rendezvous;

FIG. 6A is a flow diagram of a fuel check procedure;

FIG. 6B is a flow diagram of an emergency refueling procedure;

FIG. 7 is a flow diagram of a refueling procedure;

FIG. 8 is a side view of a first embodiment of a refueling process including a vehicle that is receiving fuel and a refueling vehicle;

FIG. 9 is a side view of a second embodiment of the refueling process including a vehicle that is receiving fuel and a refueling vehicle; and

FIG. 10 is a side view of a third embodiment of the refueling process including a vehicle that is receiving fuel and a refueling vehicle.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As described herein, an autonomous vehicle is equipped with a controller and is connected to a communication network to facilitate refueling. The vehicle communicates over the network or directly with a refueling vehicle via the controller. The communication may be triggered by a predefined refueling checkpoint created by mission control, or a critical level of fuel in a fuel tank of the vehicle. The controller of the vehicle transmits a refueling location and/or an identifying characteristic (e.g., a visual indicia, an audible sound, or combinations thereof) by which the vehicle can be identified. The vehicle travels to the refueling location. The refueling vehicle separately travels to the refueling location, identifies the vehicle, and establishes a refueling pose. As used herein, pose represents the position and the orientation of an object or objects (e.g., the vehicle, the refueling vehicle). The refueling pose may be a stationary arrangement, or a moving convoy on a road. In some instances, the stationary arrangement may be at a location along the road (e.g., the shoulder of the road) or at a location a distance away from the road (e.g., a parking lot). A refueling controller and/or operator onboard the refueling vehicle directs a refueling process. In some embodiments, the refueling process may include utilizing a mechanical arm to position a nozzle in a fuel port of the vehicle. However, it should be understood that various delivery techniques may be used during the refueling process. Fuel is transferred from a fuel tank on the refueling vehicle to the vehicle. The refueling process ends and the vehicle proceeds with a predefined mission.

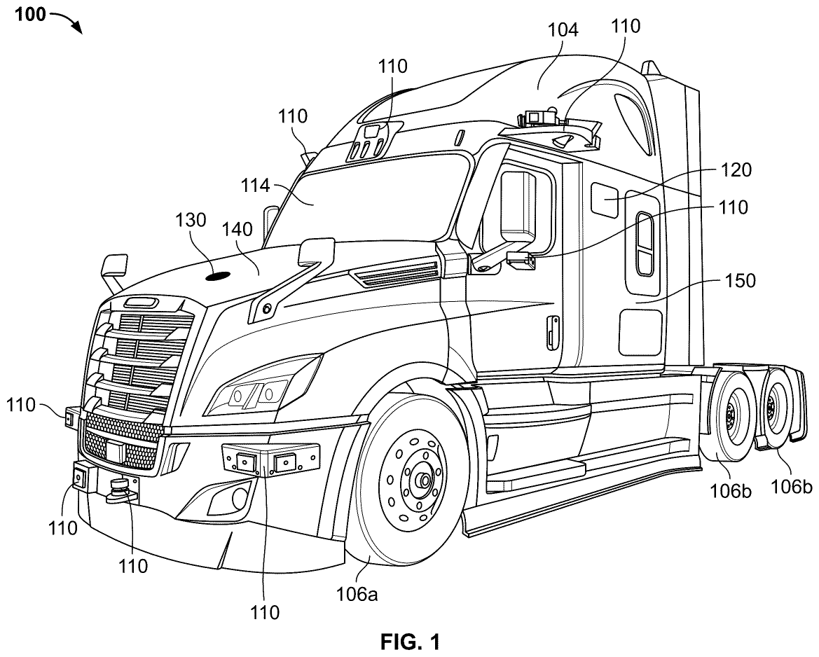

Various embodiments in the present disclosure are described with reference to FIGS. 1-10 below.

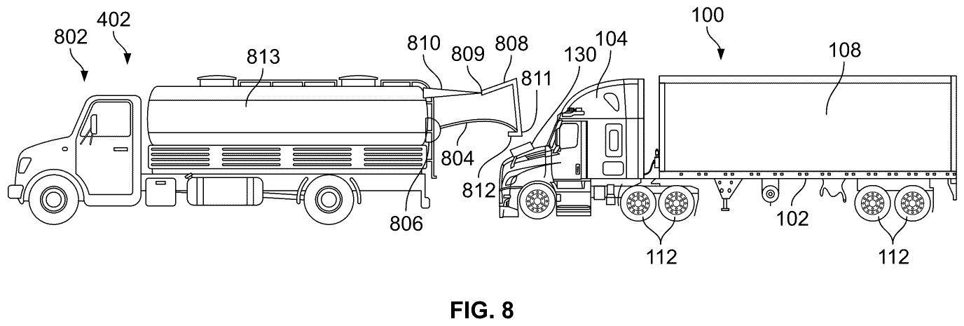

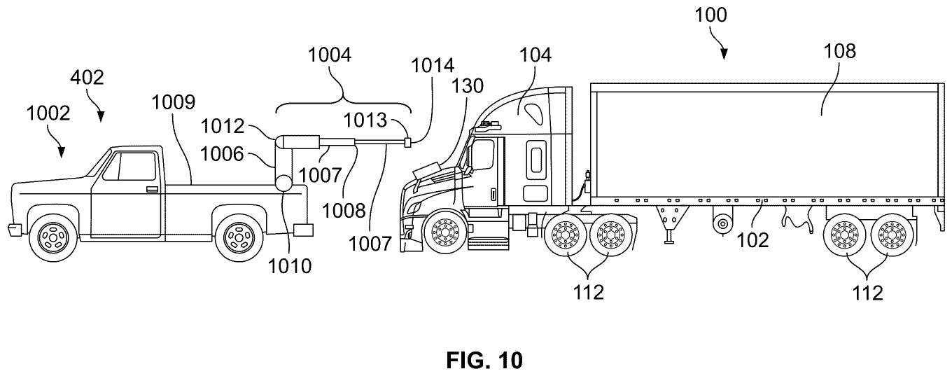

FIG. 1 is a perspective view of a vehicle 100, such as a truck. The vehicle 100 may be conventionally connected to a single or tandem trailer 102 (see FIGS. 8 and 10) to transport the trailer 102 to a desired location. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104. The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

In some embodiments, the vehicle 100 includes a visual indicia 120. The visual indicia 120 is unique to the vehicle 100 such that it can be differentiated from a fleet of like vehicles. The visual indicia may include a barcode, a QR code, a hexadecimal string, a serial number, or any other identifier known in the art which can be identified via image data. The visual indicia 120 may be located on any surface (e.g., a flat external surface) of the vehicle which is easily visible to proximate observers or cameras. Although the visual indicia 120 is depicted in FIG. 1 on a side of the cabin 104 of the vehicle 100, it should be understood that the visual indicia 120 may be positioned on any surface of the vehicle 100. For example, the visual indicia 120 may be positioned on the opposing side of the cabin 104, on a hood 140 of the vehicle 100, on a windshield 114 of the vehicle 100, and combinations and variations thereof.

In some embodiments, the vehicle 100 includes a fuel port 130. The fuel port is fluidly connected to a fuel tank (not shown) which is mounted with respect to the vehicle 100. The fuel port 130 may be positioned relative to the front end of the vehicle 100, a side portion of the vehicle 100, and/or a rear end of the vehicle 100. For example, the fuel port 130 may be positioned relative to the hood 140 of the vehicle 100, a side body panel 150 of the vehicle 100, or another easily accessible location of the vehicle 100. The fuel port 130 may include a cap (not shown), self-sealing lid (not shown), or other sealing device known in the art.

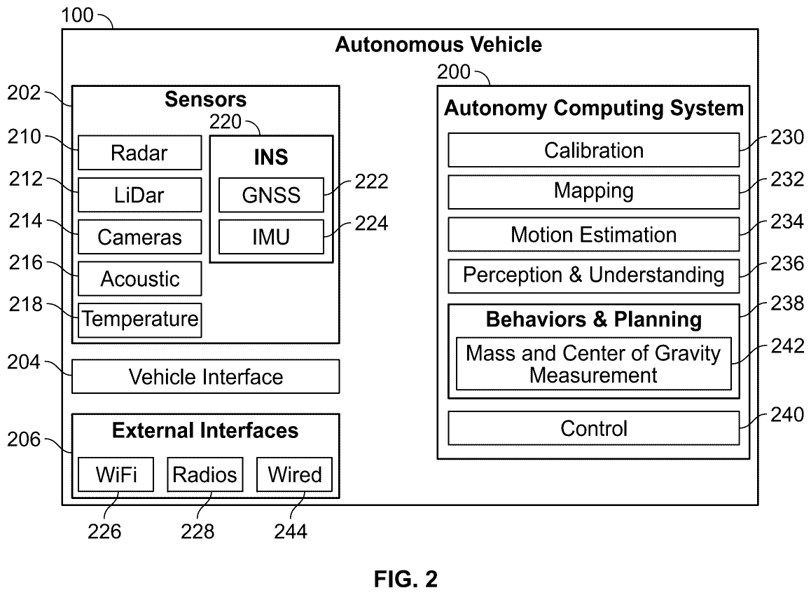

FIG. 2 is a block diagram representing autonomous vehicle 100 shown in FIG. 1. In the example embodiment, autonomous vehicle 100 generally includes autonomy computing system 200, sensors 202, a vehicle interface 204, and external interfaces 206. It should be understood that the sensors 110 on the vehicle 100 in FIG. 1 and described herein correspond to the sensors identified as 202 in FIG. 2. The sensors 110 may specifically include any of the sensors 210-220 shown in FIG. 2 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100. The autonomy computing system 200 includes a neural network capable of processing image data to identify objects or indicia in the image data. The neural network is further capable of plotting a course based on the image data and other sensor data from the RADAR sensors 210 and/or LiDAR sensors 212, for example. The image data generated by camera(s) 214 may be used by the neural network of the autonomy computing system 200 and/or the autonomous vehicle 100 to identify one or more proximate targets, which may include but are not limited to, vehicles, structures, landmarks, and combinations and variations thereof. For example, the neural network may be used to analyze the image date to identify one or more refueling vehicles. The image data generated by camera(s) 214 may be used by the neural network of the autonomy computing system 200 and/or the autonomous vehicle 100 to identify the refueling vehicle by identifying visual indicia (e.g., similar to visual indicia 120) that is positioned on and/or associated with the refueling vehicle. The autonomy computing system 200 and/or the autonomous vehicle 100 may prepare a reference path to the target based upon additional proximate objects identifiable in the image data, and/or transmit the updated reference path to other modules of the autonomy computing system 200 or mission control or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more objects around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical system (MEMS) that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering system, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.) 226.

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an object detection and reference path generator module 242. In some embodiments, the controller 240 is configured to execute instructions related to refueling of the vehicle 100. The object detection and reference path generator module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 242 may perform one or more tasks including, but not limited to, identifying objects in the environment, generating one or more paths between the vehicle and a target, updating a reference path based upon the one or more paths, and transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

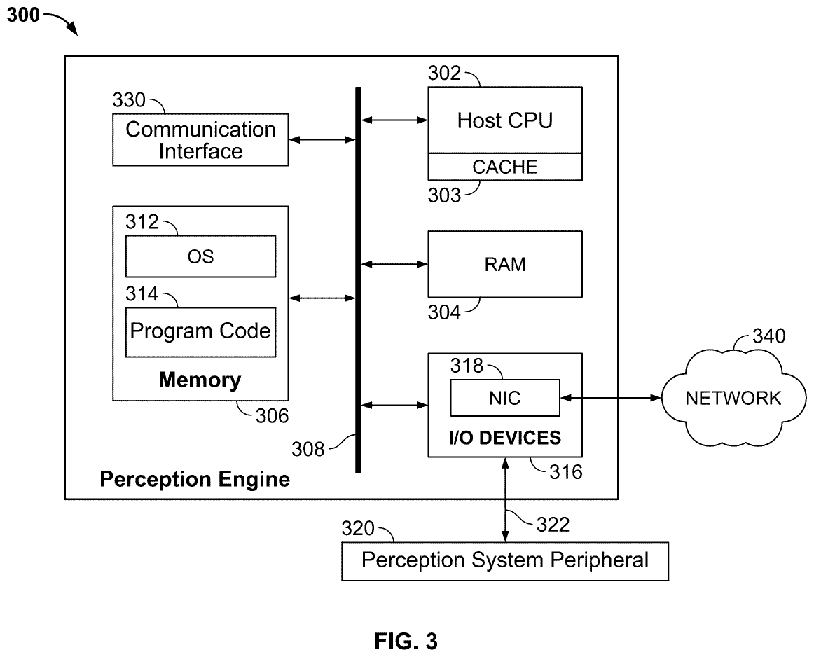

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an operating system (OS) 312 and a section storing program code 314. Program code 314 may be one of the modules in the autonomy computing system 200 shown in FIG. 2. In alternative embodiments, one or more sections of memory 306 may be omitted and the data stored remotely. For example, in certain embodiments, program code 314 may be stored remotely on a server or mass-storage device and made available over a network 340 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus. The computing system 300 can connect to the network 340 via NIC 318, which enables connection to additional vehicles, and to mission control.

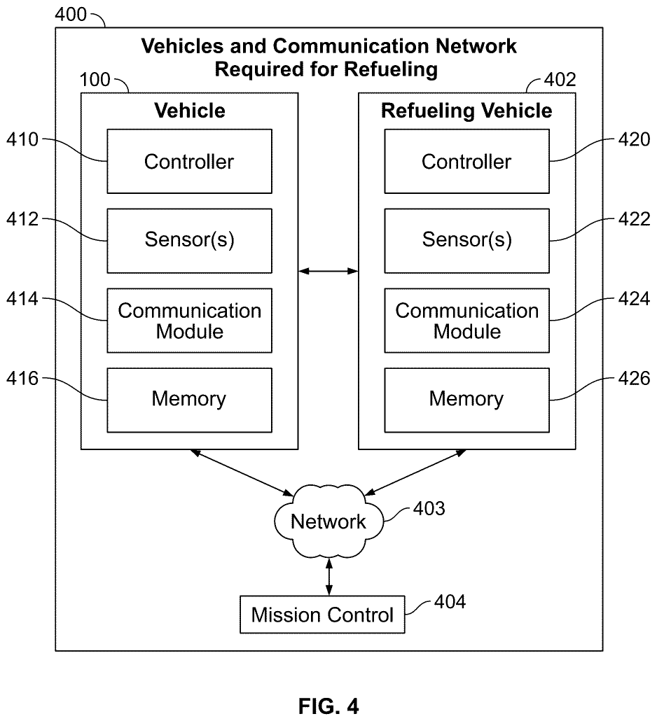

FIG. 4 shows an exemplary block diagram of the vehicles and communication network required for refueling the vehicle 100. Note, the vehicle identified at 100 in FIG. 4 is the autonomous vehicle 100 shown in FIG. 1 and described above. As shown in FIG. 4, the system 400 generally includes the vehicle 100, a refueling vehicle 402, a network 403 (e.g. network 340), and mission control 404. The vehicle 100 includes a controller 410 (e.g. computing system 200, computing system 300, or the like) configured to receive, process, and transmit data related to the refueling procedure. The vehicle 100 additionally includes one or more sensors 412 (e.g. sensors 110, sensors 202, or the like) which provide sensor data to the controller 410. Controller 410 is in communication with a communication module 414, which provides a connection between the controller 410 and the network 403. Controller 410 is in communication with a memory 416 (e.g. memory 306) which is a non-transitory computer-readable storage medium for storing instructions or communication data downloaded from network 403, sensor data from sensors 412, operating instructions, or other necessary data known in the art. The controller 410 may be coupled, either directly or indirectly, to the communication module 414, the memory 416, the sensors 412, or combinations thereof.

Refueling vehicle 402 comprises a controller 420 and one or more sensors 422 configured to execute refueling procedures. Refueling controller 420 is connected to a memory 426 for storing log data of the refueling process. Refueling vehicle 402 is additionally equipped with a communication module 424, which can receive communication either via the network 403 or directly from vehicle 100. In some embodiments, refueling vehicle 402 is a human controlled vehicle. In other embodiments, refueling vehicle 402 is an autonomous vehicle, in which case the refueling vehicle includes at least a portion of the functionality of vehicle 100, as described above.

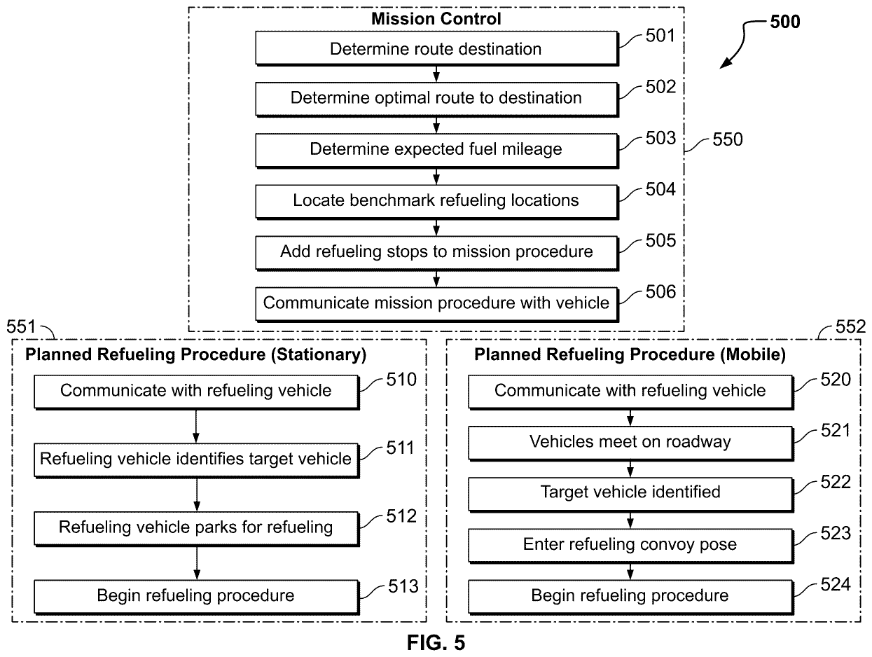

FIG. 5 shows a flow diagram for a planned refueling procedure 500. The planned refueling procedure 500 is split into two discrete sub-procedures, a planning procedure 550 and a refueling procedure 551. The planning procedure 550 may be accomplished by the mission control 404, identified in FIG. 4. The refueling procedure 551 may be accomplished by the vehicle controller 410, identified in FIG. 4. In some embodiments, the refueling procedure 551 may be completed two or more times along a route.

The planning procedure 550 is executed by the mission control 404 prior to vehicle 100 departing on a mission. Under normal operating circumstances, a route of travel for vehicle 100 will be known prior to departure from a starting point. A destination of the route is identified by mission control in 501. The mission control 404 determines the optimal route of vehicle travel to reach the destination based upon a variety of conditions, including, for example, route specific weather, traffic, tolls, and/or other factors in 502. The mission control 404 determines in 503 the expected fuel mileage of the vehicle 100. To determine the expected fuel mileage of the vehicle 100, the mission control 404 may consider the tank capacity, the optimal route as identified in 502, and other factors, as required (e.g., size and/or weight of the trailer 102). Mission control 404 utilizes the route identified in 502 and the fuel data identified in 503 to determine a series of pre-planned refueling checkpoints for the mission in 504. Refueling checkpoints may be selected by factoring various conditions of the vehicle 100 and the route of the vehicle 100. In some instances, the refueling frequency/timing and refueling locations may be coordinated such that they have little impact on the overall route. In some embodiments, the timing and location of each refueling checkpoint may be based on an expected arrival time of the vehicle 100. In some embodiments, the refueling checkpoint may be a specific location with the timing dependent on the vehicle reaching a route checkpoint. For example, the timing of the refueling checkpoint may be calculated based on a time at which the vehicle 100 is expected to reach a route location a distance away from the refueling checkpoint location. In some instances, the expected fuel mileage of the vehicle 100 may be considered in determining a refueling checkpoint. For example, the refueling checkpoint may be spaced from the start location, the end location, and/or other refueling checkpoints along the route based on a predetermined range of the expected fuel mileage of the vehicle 100. The spacing of the refueling checkpoints may be evenly or unevenly spaced, depending, in part, on the conditions along the route and the expected fuel mileage of the vehicle 100. The frequency/timing and locations of these refueling checkpoints are added to the mission in 505, which is communicated to the vehicle 100 and one or more refueling vehicles 402 over the network 403. In some embodiments, the timing and locations of the refueling checkpoints is primarily transmitted to refueling vehicles stationed proximate the respective refueling checkpoints. Refueling checkpoints may comprise a parking lot, weigh station, shoulder of a roadway, or other locations where two vehicles may safely stop, and complete autonomous vehicle refueling.

According to some embodiments of the planned refueling procedure 551, as the vehicle 100 approaches or arrives at a refueling checkpoint, vehicle controller 410 communicates with a proximate refueling vehicle 402 in 510. Vehicle controller 410 may communicate with proximate refueling vehicle 402 as soon as practicable (e.g. as soon as a substantially uninterrupted vehicle-to-vehicle communication link is established). The timing of the communication may be dependent on a communication network (e.g. cellular, radio, Bluetooth, Wi-Fi, etc.) used by the vehicle 100 and refueling vehicle 402, and other regional factors such as geography and weather. Vehicle controller 410 may send several communication requests before the vehicle-to-vehicle communication link is successfully established. Vehicle controller 410 may send communication requests as soon as the refueling checkpoint is confirmed, for example. Alternatively or additionally, vehicle controller 410 may attempt to establish communication once a certain expected time of arrival is reached. For example, once the vehicle 100 is approximately 30 minutes away from the refueling checkpoint, vehicle controller 410 may send a vehicle-to-vehicle communication request to proximate refueling vehicle 402. In some embodiments, vehicle controller 410 will communicate with a nearby hub location as the vehicle 100 approaches or arrives at the refueling checkpoint. The nearby hub location relative to the refueling checkpoint may then dispatch the refueling vehicle 402 to the refueling checkpoint. Vehicle controller 410 transmits the refueling checkpoint location, travel characteristics of the vehicle 100 (e.g., the estimated time of arrival), and the visual indicia 120 of vehicle 100 to the refueling vehicle 402. Vehicle 100 will stop at the refueling location and await the refueling vehicle 402. In some embodiments, vehicle 100 sends an additional message to refueling vehicle 402 with its precise location to ensure the refueling vehicle 402 is able to identify vehicle 100 efficiently. Refueling vehicle 402 arrives at the location of the vehicle 100 and verifies the vehicle 100 by the previously provided identifying visual indicia 120, as described in 511. In some cases, the visual indicia 120 may require a visual sensor and controller to decipher (i.e. in the case of a QR code). In other cases, the visual indicia may be visually identified by a human operator. In 511, once vehicle 100 has been identified, the refueling vehicle 402 establishes the refueling pose with vehicle 100. The refueling vehicle 402 will then park relative to the vehicle 100 in 512. The refueling vehicle 402 may determine its parking position relative to the vehicle 100 based, in part, on the location of the fuel port 130 of the vehicle 100. For example, the refueling vehicle 402 may park in front of the vehicle 100 when the fuel port 130 is located towards the front end of the vehicle 100, as depicted in FIG. 1. The refueling vehicle 402 then initiates the refueling procedure in 513.

In some cases, the refueling vehicle 402 will arrive at the refueling checkpoint first. In such a scenario, the refueling vehicle communicates a location and its own refueling vehicle visual indicia (not shown) to the vehicle 100. The vehicle controller 410 then utilizes the object detection and reference path generator module 242 to identify the refueling vehicle 402, and determine a path (i.e. through a parking lot) to rendezvous with the refueling vehicle.

According to alternative embodiments of the refueling procedure, the refueling locations may be coordinated to enable refueling operations that occur while the vehicle 100 is operating, and in motion. This procedure is represented in mobile refueling procedure 552 of FIG. 5. Instead of providing a specific stop location to the refueling vehicle in 510, vehicle controller 410 provides the refueling vehicle with the visual indicia 120 and data regarding the travel parameters of vehicle 100 in 520. Such data could include movement parameters such as GNSS data, IMU data, velocity, expected maneuvers, and other relevant travel data or motive characteristics. Using the travel and motive characteristics data, refueling vehicle 402 attempts to meet vehicle 100 on the roadway by approximately matching the movement parameters in 521. Once within visual distance, the refueling vehicle 402 will identify the vehicle 100 via the visual indicia 120 in 522. The refueling vehicle 402 will attempt to position itself relative to the vehicle 100 in 523 while both vehicles are underway, and in motion. As discussed above, the positioning of the refueling vehicle 402 relative to the vehicle 100 may depend, in part, on the location of the fuel port 130 of the vehicle 100. For example, the refueling vehicle 402 may position itself in front of the vehicle 100 when the fuel port 130 is located towards the front end of the vehicle 100, as depicted in FIG. 1. In 523, vehicle controller 410 controls vehicle 100 to position the vehicle 100 relative to the refueling vehicle 402 in a refueling convoy pose. For example, the vehicle controller 410 controls vehicle 100 to position the vehicle 100 behind the refueling vehicle 402 in the refueling convoy pose. In the refueling convoy pose, both vehicles may be positioned in the same lane and, in such instances, the refueling vehicle 402 may be positioned ahead of vehicle 100. However, it should be understood that both vehicles may be positioned in adjacent lanes without departing from the spirit/scope of this disclosure. Vehicle controller 410 utilizes a pose estimation program to calculate the position and spatial orientation of the refueling vehicle 402 ahead and maintain a constant orientation and position relative to the refueling vehicle 402 while both travel along the road. The pose estimation program receives inputs from sensors 412 which include data regarding the environment, proximate objects, the orientation of the refueling vehicle, and the position of the refueling vehicle. In some embodiments, if the refueling vehicle 402 is autonomous or semi-autonomous, the refueling vehicle 402 follows an analogous procedure to maintain pose with the vehicle 100. In some embodiments, the refueling vehicle 402 and vehicle 100 actively communicate while entering the refueling convey pose to provide information regarding steering and throttle inputs, expected obstacles, and other information pertinent to controlling a vehicle. A stable refueling convoy pose may be achieved when both vehicles are substantially synchronized while in motion. Once in a stable refueling convey pose, refueling vehicle 402 initiates the refueling procedure in 524. In some embodiments, the lead vehicle of vehicle 100 and refueling vehicle 402 will coordinate the refueling convoy pose. In some embodiments, vehicle 100 or refueling vehicle 402 may identify a potentially dangerous scenario and request a delay in establishing the refueling convoy pose.

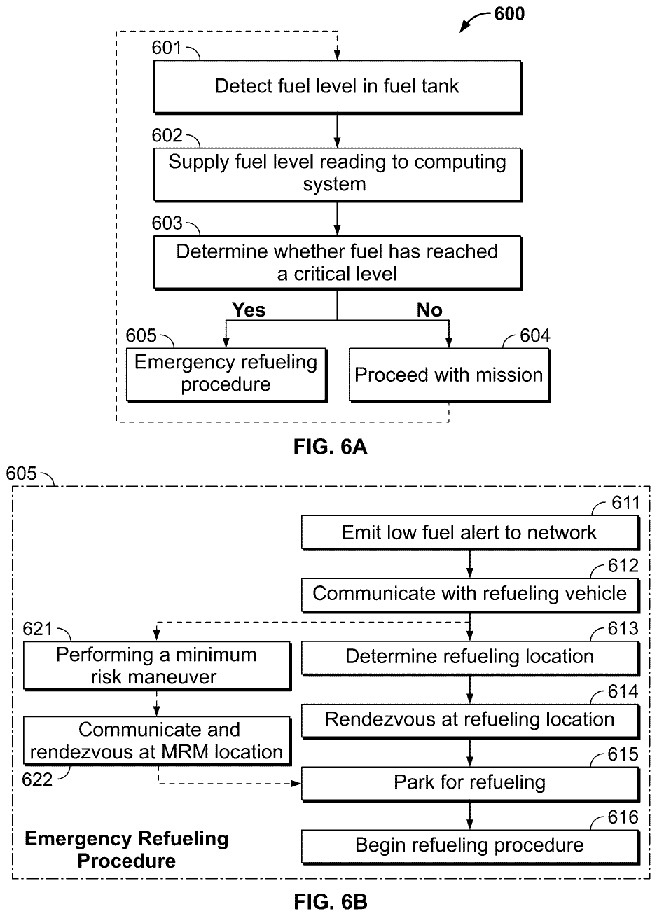

FIG. 6A shows a flow diagram of a fuel check procedure 600. Under certain circumstances, the vehicle 100 may reach a critical level such as a threshold level of fuel requiring refueling earlier than planned or anticipated. A critical level of fuel may indicate that the vehicle 100, based, in part, on the estimations of fuel remaining, does not have enough fuel to reach a previously determined refueling checkpoint and/or a destination. The critical level of fuel may be a predetermined threshold, such as, for example, a percent fuel remaining in the vehicle 100, a specific volume of fuel remaining in the vehicle 100, A critical level scenario may occur when the vehicle 100 has an undetected fuel leak, traffic along the route caused slower travel than anticipated, the vehicle encountered a substantial headwind, assumptions regarding fuel consumption were incorrect, other factors, and combinations and variations thereof. To ensure such a scenario does not leave vehicle 100 stranded, the vehicle 100 is configured to perform the fuel check procedure 600 intermittingly along a route. In some instances, the vehicle 100 is configured to perform the fuel check procedure 600 continuously along a route. The instances when the vehicle 100 may perform the fuel check procedure 600 may include, but are not limited to, the passage of a certain amount of time; before, after, and/or during the completion of a task; before, after, and/or during travel-based events; and combinations thereof. Vehicle 100 is configured to detect the fuel level in the fuel tank, as indicated by 601. The fuel tank (not shown) of vehicle 100 may be equipped with a fuel sensor (not shown) to detect the amount of fuel remaining. The fuel sensor may be a float switch, fuel level sensor, or other commonly used sensors for detecting the amount of liquid remaining in a container. Fuel data from the fuel sensor is provided to the vehicle controller 410 in 602. In 603, the vehicle controller 410 makes a determination as to whether the fuel has reached the critical level. The determination may be relative to a threshold, based on expected fuel mileage for the remainder of the mission, or based on other mission factors. If the vehicle controller 410 determines that the criteria for a critical level of fuel has not been met, then vehicle 100 proceeds with the mission while the vehicle controller continues to monitor the amount of fuel. If the criteria for a critical level of fuel has been met, vehicle controller 410 initiates an emergency refueling procedure 605, as shown in FIG. 6B. Although identified as an “emergency”, it should be understood that the refueling procedure 605 described below and depicted in FIG. 6 may be used during emergency and non-emergency situations.

Referring to FIG. 6B, during the emergency refueling procedure 605, vehicle controller 410 emits a low fuel alert via network 403 in 611. The message may be received by proximate refueling vehicles 402, in which case the nearby available refueling vehicle 402 will rendezvous with vehicle 100. The message may also be received by a nearby hub location, which can dispatch a refueling vehicle 402 if such a dispatch would result in a faster rendezvous. Vehicle controller 410 can begin communicating with the nearby available refueling vehicle in 612. The nearby available refueling vehicle 402 may be selected based on an amount of time required for the refueling vehicle 402 to reach vehicle 100, based on the amount of distance between the refueling vehicle 402 and the vehicle 100, or combinations thereof. In 613, vehicle controller 410 of vehicle 100 determines a refueling location and communicates the refueling location with the refueling vehicle 402. The process of determining the refueling location may be based on one or more factors, including, but not limited to, convenience for the refueling vehicle 402 and/or the vehicle 100, amount of fuel remaining in the vehicle 100, expected fuel mileage of the vehicle 100, and other factors. The controller 420 may control the vehicle 100 to reach the refueling location. In 614, vehicle 100 and refueling vehicle 402 rendezvous at the refueling location in the same manner as in 511 of the planned refueling procedure 551. The execution of parking coordination and refueling in 615 and 616 respectively are also described in 512 and 513 of the planned refueling procedure 551.

In some scenarios, for example, emergency scenarios, the fuel level of the vehicle 100 may be sufficiently low that vehicle 100 is required to stop sooner than anticipated. In such a situation, prior to determining an optimal refueling location, as described above in 613, the vehicle 100 may instead execute a minimum risk maneuver (MRM) in 621. Thus, after communication with the nearby available refueling vehicle 402 has occurred in 612, the vehicle 100 will execute the MRM in 621. During such a maneuver, the vehicle controller 410 identifies a safe, efficient path to a safe location out of the flow of traffic, and begins to execute a route to the safe location. The safe location may be a parking lot, a shoulder along the roadway, a weigh station, and combinations and variations thereof. Once safely out of the flow of traffic, vehicle controller 410 communicates the safe location with the nearby available refueling vehicle 402 and requests a rendezvous at that location in 622. The refueling vehicle 402 will then locate vehicle 100 using the visual indicia 120 as described above and park in 615. Refueling vehicle 402 will then begin the refueling procedure in 616, as described herein.

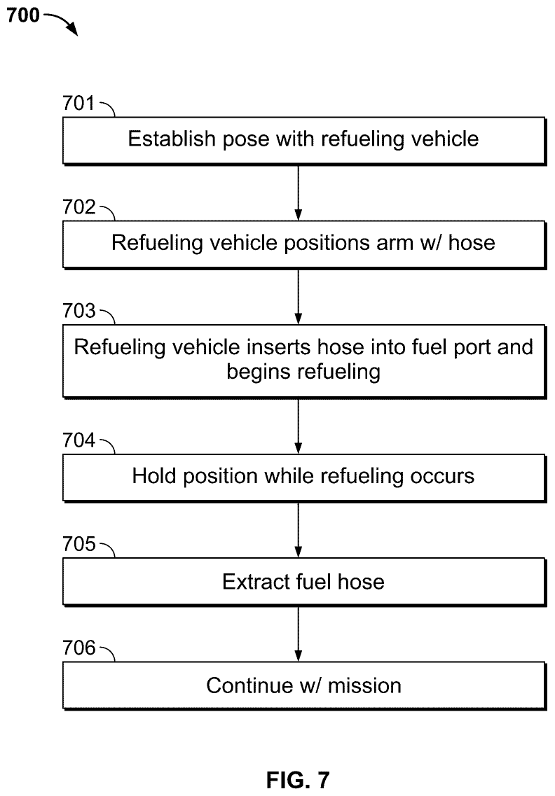

The method 700 shown in FIG. 7 is completed before the previously described refueling procedures 513 or 616 are initiated. Turning now to method 700 of FIG. 7, in 701, the refueling pose is established between vehicle 100 and refueling vehicle 402. As described above, the refueling pose may be a stationary position where refueling vehicle 402 is positioned relative to the vehicle 100, or it may be a convey pose while both vehicles travel along a roadway. In some embodiments, in either the stationary position or the convey pose, the refueling vehicle 402 is spaced a distance relative to the front end of the vehicle 100 of about 16.4 feet (5 meters) to about 26.2 feet (8 meters). In 702, at least a portion of the fuel delivery device of the refueling vehicle 402 are aligned with at least a portion of the fuel receiving features of the vehicle 100. In 703, the refueling vehicle 402 inserts a fuel delivery device into the fuel port 130 and begins transferring fuel to vehicle 100. In some embodiments, vehicle 100 is provided with a clamp in the fuel port 130 which locks the fuel delivery device in place. In 704, while in the convey pose, vehicle controller 410 maintains orientation and position behind refueling vehicle 402. Otherwise, both vehicles simply maintain their parked positions. In some embodiments, refueling vehicle 402 is equipped with a sensor which determines when the fuel tank of vehicle 100 is full. In some alternative embodiments, vehicle controller 410 transmits fuel data from the fuel sensor which indicates the volume of fuel in the fuel tank. In some embodiments, the specific volume of fuel required to refuel the vehicle is transmitted to the refueling vehicle 402. Once refueling is complete, refueling vehicle 402 disconnects the fuel delivery device from the fuel receiving features of the vehicle in 705. Refueling may be complete when, for example, the fuel tank is full and/or an amount of fuel required to reach the next refueling checkpoint or destination has been provided. Once the fuel receiving features are secured, the vehicle 100 may continue with the mission in 706. The movement of the mechanical arm and the flow of fuel through the hose may be controlled, either directly or indirectly, by an operator of the refueling vehicle 402 and/or the refueling controller 420.

FIGS. 8-10 show exemplary embodiments of the refueling process. In FIG. 8, the refueling vehicle 402 is a tanker 802. The tanker 802 includes the hose 804 mounted in fluid communication with a fuel storage tank 813. The hose 804 may be coupled to a spool 806. In some instances, the spool 806 may be in fluid communication with the fuel storage tank 813. The spool 806 may be mounted with respect to a surface of the tanker 802. The hose 804 may be wound around the spool 806. A strut 810 is mounted to the tanker 802 proximate the spool 806. The mechanical arm 808 is mounted to an end 809 of the strut 806. A nozzle 812 is removably coupled to a distal end 811 of the mechanical arm 808. The hose 804 terminates in nozzle 812. Vehicle 100 is shown as a truck towing a trailer with an intermodal shipping container. The cab 104 of vehicle 100 is equipped with fuel port 130, which can receive nozzle 812. The mechanical arm 808 is operated by either an operator of tanker 802, or by a controller (e.g. refueling controller 420). As the mechanical arm 808 moves the nozzle 812, the hose 804 is unwound from the spool 806 as required to enable the arm 808 to position the nozzle near the fuel port 130. Nozzle 812 is positioned in fuel port 130, and then the fuel flows from fuel storage tank 813 to the fuel tank of vehicle 100. After the nozzle is located in the fuel port 130, the nozzle 812 may be disconnected from the mechanical arm 808 using any of an electromagnet, latch mechanism, or other similar selectively detachable mechanism, such that the mechanical arm may be removed during the refueling process. For example, the mechanical arm 808 may be used to guide and position the nozzle 812 into fuel port 130. After the nozzle 812 is inserted into the fuel port, the mechanical arm 808 is detached until the refueling process is complete. The mechanical arm 808 may then be re-attached to the nozzle. The arm 808 is then repositioned to remove the nozzle 812 from the fuel port 130. In such embodiments, the convey pose is more easily achievable due, in part, because the hose 804 provides a greater margin of error for minor relative movements between the two vehicles than the rigid mechanical arm 808. The nozzle 812 is removed by mechanical arm 808 when refueling is complete, and fuel port 130 is resealed. Spool 806 is rewound to collect the hose 804.

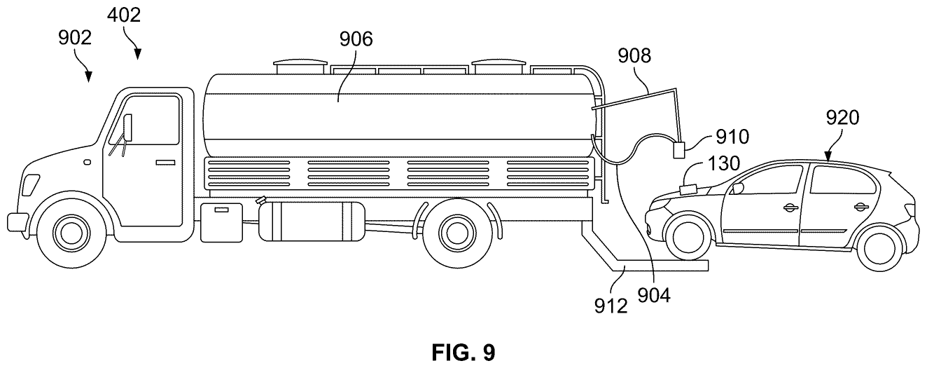

In FIG. 9, an alternative embodiment of the refueling process is shown. Refueling vehicle 402 is shown as a tanker 902. Vehicle 100 is shown as a passenger vehicle 920. Although depicted as a vehicle smaller than the vehicles shown in FIGS. 1 and 8, for example, it should be understood that passenger vehicle 920 may be similarly-sized without departing from the spirit/scope of this disclosure. The hose 904 is mounted with respect to a fuel tank 906 of tanker 902. The hose 904 is in fluid communication with the fuel tank 906. The hose 904 may be mounted with respect to a rear of the fuel tank 906, a side of the fuel tank 906, and combinations thereof. The mechanical arm 908 is additionally mounted to the fuel tank 906 proximate the hose 904. Mechanical arm 908 includes a distal end which is connected to a nozzle 910. Hose 904 is coupled to the nozzle 910. The mechanical arm 908 is moveable such that the nozzle 910 can be inserted into the fuel port 130 of passenger vehicle 902. The mechanical arm 908 is operated by either an operator of tanker 902, or by a controller (e.g. refueling controller 420). A restraining ramp 912 is mounted to tanker 902, which is intended to restrain a vehicle during refueling. The restraining ramp 912 may be mounted to a rear end of tanker 902, or may be mounted to a side of tanker 902. During refueling, fuel flows from the fuel tank 906 to a fuel tank of passenger vehicle 920 via hose 904, nozzle 910, and fuel port 922. To maintain pose during a refueling operation, passenger vehicle 920 drives onto ramp 912. The ramp 912 keeps passenger vehicle 920 in place for the duration of the refueling operation. Nozzle 910 is removed from fuel port 922 at the end of refueling, and passenger vehicle 920 backs away from ramp 912.

In FIG. 10, a third alternative embodiment of the refueling process is shown. Refueling vehicle 402 is shown as a pickup truck 1002 which includes a storage tank for fuel (not shown). A refueling arm 1004 is mounted to the pickup truck 1002 at an attachment point 1010. The attachment point 1010 may be located in a bed 1009 of the pickup truck 1002, or may be positioned at a rear portion or side portion of the pickup truck 1002. A base 1006 of refueling arm 1004 is attached to the attachment point 1010. The base 1006 has a distal end 1012. A telescoping segment 1008 is connected to the distal end 1012 of the base 1006. The telescoping segment 1008 includes a plurality of nested concentric tube elements 1007 which may be extended away from distal end 1012. A nozzle 1014 is mounted to an end 1013 of the telescoping segment 1008. A hose (not shown) may be positioned within the refueling arm 1004 such that it passes through at least the base 1006 and telescoping segment 1008 and terminates at nozzle 1014. The refueling arm 1004 may additionally include a fuel pump to transfer fuel from the storage tank to the nozzle 1014. The base 1006 may include a joint (not shown) at either the attachment point 1010 or the distal end 1020. In some embodiments, the joint is a swivel joint. The telescoping segment 1008 and the joint are configured such that the nozzle 1014 can be positioned anywhere in a substantially sphere-shaped three dimensional space centered at the joint and with a radius equivalent to a maximum extension of the telescoping segment 1008. Vehicle 100 is shown as a truck towing a trailer with an intermodal container. The cab 104 of vehicle 100 is equipped with the fuel port 130 which can receive nozzle 1014. The refueling arm 1004 is operated by either an operator of pickup truck 1002 or by a controller (e.g. refueling controller 420). Nozzle 1014 is positioned in fuel port 1022, and fuel flows from the storage tank to the fuel tank of vehicle 100. Nozzle 1014 is removed when refueling is complete and fuel port 1022 is resealed.

In non-limiting examples, FIGS. 8-10 illustrate various refueling embodiments which may be relied on to provide context to the refueling procedure depicted in FIG. 7. For example, refueling vehicle 402 may be equipped with a fuel delivery device (e.g., hose 804, 904) at least configured to deliver fuel to vehicle 100. In some instances, the vehicle 100 may include a fuel receiving feature (e.g., fuel port 130) at least configured to receive fuel from refueling vehicle 402. In some embodiments, the fuel delivery device (e.g., hose 804, 904) described with respect to the refueling vehicle 402 may be included as part of the vehicle 100. In some embodiments, the fuel delivery device may be mounted with respect to a positioning device (e.g., the mechanical arm) 808, 908, 1004. For example, the mechanical arm 808, 908, 1004 of the refueling vehicle 402 may be configured to locate the hose 804, 904 relative to the vehicle 100 so as to deliver fuel to the vehicle 100.

In one example and referring to FIG. 8, the fuel delivery device of the refueling vehicle 402 may include the mechanical arm 808 which may be configured to position the hose 804 relative to the fuel receiving features (e.g., fuel port 130) of the vehicle 100. In another example and referring to FIG. 9, refueling vehicle 402 may include a mechanical arm 908 which may be configured to position the hose 904 relative to the fuel receiving features (e.g. fuel port 130) of vehicle 100 while vehicle 100 is coupled with refueling vehicle 402. In another example and referring to FIG. 10, refueling vehicle 402 may include a refueling arm 1004 which may be configured to position a nozzle relative to the fuel receiving features (e.g. fuel port 130) of vehicle 100. The refueling arm 1004 may be configured to transfer fuel from the refueling vehicle to the vehicle 100 with a hose contained within the refueling arm.

In some embodiments, the refueling vehicle 402 is equipped with a rear-facing refueling camera (not shown), which provides the operator with an unobstructed view of the mechanical arm and vehicle 100 via a display (not shown) mounted in the refueling vehicle 402. The refueling camera enables the operator to maneuver the mechanical arm into position such that the hose can be inserted into the fuel port 130. Furthermore, in some embodiments, the refueling vehicle 402 is equipped with a joystick (not shown) for controlling the mechanical arm.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

As used herein, the term “about” refers to a measurable value such as a parameter, an amount, a temporal duration, and the like and is meant to include variations of +/−15% or less, preferably variations of +/−10% or less, more preferably variations of +/−5% or less, even more preferably variations of +/−1% or less, and still more preferably variations of +/−0.1% or less of and from the particularly recited value, in so far as such variations are appropriate to perform in the one or more embodiments of the disclosure described herein. Furthermore, it is also to be understood that the value to which the modifier “about” refers is itself specifically disclosed herein.

As used herein, spatially relative terms, such as “beneath”, “below”, “lower”, “above”, “upper”, “front”, “back”, “side”, “left”, “right”, “rear”, “top”, “bottom”, and the like, are used for ease of description to describe one element or feature's relationship to another element(s) or feature(s). It is further understood that the terms “front”, “back”, “left”, and “right” are not intended to be limiting and are intended to be interchangeable, where appropriate. Further, it should be noted that the terms “first,” “second,” and the like herein do not denote any order, quantity, or relative importance, but rather are used to distinguish one element from another.

All methods described herein can be performed in any suitable order unless otherwise indicated herein or otherwise clearly contradicted by context. The use of any and all examples, or exemplary language (e.g., “such as”), is intended merely to better illustrate the present disclosure and does not pose a limitation on the scope of the present disclosure or any embodiments unless otherwise claimed.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for providing fuel to an autonomous vehicle, including at least one autonomous vehicle sensor and an autonomous vehicle identification indicia, the system comprising:
a communication network configured to communicate between the autonomous vehicle and a refueling system, wherein a refueling location is communicated therebetween; and
a controller configured to provide to the refueling system travel characteristics of the autonomous vehicle, provided by the at least one autonomous vehicle sensor, and the autonomous vehicle identification indicia,
wherein the controller is configured to operate the autonomous vehicle;
wherein the refueling system is configured to identify the autonomous vehicle by the autonomous vehicle identification indicia, and
wherein the refueling system is configured to provide fuel to the autonomous vehicle at the refueling location.

2. The vehicle of claim 1, wherein the refueling location is provided by the autonomous vehicle or the refueling system.

3. The vehicle of claim 1, the controller is configured to receive an input from a fuel sensor in communication with a fuel tank of the autonomous vehicle, wherein the controller is configured to determine if an amount of fuel stored in the fuel tank has reached a predetermined level.

4. The vehicle of claim 3, wherein the refueling location is based on whether the amount of fuel in the fuel tank has reached the predetermined level.

5. The vehicle of claim 1, wherein the controller is configured to maintain a predetermined distance between the autonomous vehicle and the refueling system, wherein the autonomous vehicle is traveling along a roadway, wherein the refueling system is a refueling vehicle traveling along the roadway in proximity to the autonomous vehicle.

6. A method for refueling an autonomous vehicle, the method comprising:
receiving, via a communication module, a refueling location from a mission control system, wherein the communication module is in communication with a controller of the autonomous vehicle;
controlling, via the controller, the movement of the autonomous vehicle to the refueling location;
communicating with a refueling vehicle to provide both a visual indicia identifying the autonomous vehicle and the refueling location;
rendezvousing with the refueling vehicle at the refueling location;
maintaining a refueling pose, wherein the refueling vehicle is positioned in proximity to the autonomous vehicle; and
delivering fuel from the refueling vehicle to the autonomous vehicle.

7. The method of claim 6, wherein the controller of the autonomous vehicle comprises a pose estimation program configured to maintain the orientation and position of the autonomous vehicle relative to the refueling vehicle.

8. The method of claim 6, wherein the refueling pose comprises maintaining a predetermined distance between the autonomous vehicle and the refueling vehicle while both vehicles are in motion.

9. The method of claim 6 further comprising identifying the visual indicia of the autonomous vehicle at the refueling location by the refueling vehicle to verify the desired autonomous vehicle has arrived at the refueling location.

10. The method of claim 6, wherein the refueling pose comprises maintaining a predetermined distance between the autonomous vehicle and the refueling vehicle while both vehicles are stationary.

11. The method of claim 6, wherein delivering fuel from the refueling vehicle to the autonomous vehicle further comprises connecting a fuel delivery device of the refueling vehicle to a fuel receiving feature of the autonomous vehicle and delivering fuel from the refueling vehicle to the autonomous vehicle.

12. A method for refueling an autonomous vehicle, the method comprising:
detecting, based on a sensor input, the amount of fuel remaining in a fuel tank of the autonomous vehicle;
determining, using a controller of the autonomous vehicle, whether the amount of fuel remaining in the fuel tank has reached a predetermined level relative to the capacity of the fuel tank;
broadcasting, via a communication module in communication with the controller, a low fuel alert to a network of refueling vehicles;
identifying a refueling location;
controlling, via the controller, the movement of the autonomous vehicle to the refueling location;
providing, to the refueling vehicle, a visual indicia which identifies the autonomous vehicle;
rendezvousing at the refueling location;
maintaining a refueling pose, wherein the autonomous vehicle is positioned in proximity to the refueling vehicle; and
delivering fuel from the refueling vehicle to the autonomous vehicle.

13. The method of claim 12, wherein the controller of the autonomous vehicle comprises a pose estimation program configured to maintain the orientation and position of the autonomous vehicle relative to the refueling vehicle.

14. The method of claim 12, The method of claim 6, wherein the refueling pose comprises maintaining a predetermined distance between the autonomous vehicle and the refueling vehicle while both vehicles are in motion.

15. The method of claim 12, further comprising identifying the visual indicia of the autonomous vehicle at the refueling location by the refueling vehicle to verify the desired autonomous vehicle has arrived at the refueling location.

16. The method of claim 14, wherein the refueling pose comprises maintaining a predetermined distance between the autonomous vehicle and the refueling vehicle while both vehicles are stationary.

17. The method of claim 12, delivering fuel from the refueling vehicle to the autonomous vehicle further comprising connecting a fuel delivery device of the refueling vehicle to a fuel receiving feature of the autonomous vehicle and delivering fuel from the refueling vehicle to the autonomous vehicle.

18. The method of claim 12, wherein the controller continuously determines the fuel level during a mission.

19. The method of claim 12, wherein identifying the refueling location comprises selecting the refueling location based on the amount of fuel remaining and expected mileage of the autonomous vehicle.
